(19) United States
(12) Patent Application Publication
(10) Pub. No.: US 2016/0311042 A1
(43) Pub. Date: Oct. 27, 2016

(54) ADJUSTABLE DEBURRING TOOL AND ADAPTER THEREFOR

(71) Applicant: NOGA ENGINEERING & TECHNOLOGY (2008) LTD., Shlomi (IL)

(72) Inventor: Eitan YEHUD, Nahariya (IL)

(21) Appl. No.: 14/691,697

(22) Filed: Apr. 21, 2015

(51) Int. Cl. B23D 71/10; B23C 5/16; B23D 71/00

(52) U.S. Cl. CPC B23D 71/10; B23D 71/005; B23C 5/16; B23C 2220/20; B23C 2260/04; B23C 2260/48

(57) ABSTRACT

An adjustable deburring tool includes a body; a rotatable deburring tip, mounted on or configured to be mounted on the body, which is configured to be rotated when powered by a power unit; and an adapter configured to be mounted over the deburring tip, when the deburring tip is mounted on the body, the adapted comprising a tube for at least partially accommodating the deburring tip, wherein the tube includes a notch through which a portion of the deburring tip extends by an adjustable extent of exposure, for performing deburring, and wherein a central axis of the tube is eccentric to a central axis of the deburring tip when the deburring tip is mounted on the body so that the extent of exposure is regulated by rotating the tube.

### FIELD OF THE INVENTION

The present invention relates to deburring. More specifically, the invention relates to an adjustable deburring tool and adapter therefor.

### BACKGROUND OF THE INVENTION

Machining processes, such as, for example, in computer numeric control (CNC) lathes, milling, chipping, grinding, etc., are typically accompanied by undesired burrs that remain on the processed workpiece. Usually, burrs are removed by the use of a deburring tool.

There are several types of deburring processes, e.g., manual, thermal, electrochemical, cryogenic, etc.

In manual removal of burrs, a specifically designed deburring tool is used, having a deburring tip at its end and hand-operated by the user, who applies the tool on the workpiece to remove burrs. The user holds the deburring tool by its handle and removes burrs by applying the rough deburring tip on the burrs. The deburring tip peels off the burr, revealing a clean surface underneath it. When a user is faced with a long manual deburring task extending over long hours of work, non-uniformity may set in, due to human fatigue and failing tolerance.

There are situations in which technicians use the chipping machine itself for a final cut, but this is not a proper way to industrially handle removal of burrs, nor is it suitable for a large variety of products (e.g., rubber-injected or plastic-injected products).

Burrs of varying sizes may require different operation profile of the deburring tool. There is known a deburring tool with a tip cover that includes two notches, each notch of different depth, so that each notch presents a different profile of the deburring tip (greater or smaller).

It is desired to provide, for burrs of varying sizes, a deburring tool presenting a continuously varying profile.

### SUMMARY OF THE INVENTION

There is thus provided, according to some embodiments of the present invention, an adjustable deburring tool. The deburring tool may include a body designed to be hand-held; a rotatable deburring tip, mounted on or configured to be mounted on the body, which is configured to be rotated when powered by a power unit; and an adapter configured to be mounted over the deburring tip, when the deburring tip is mounted on the body, the adapted comprising a tube for at least partially accommodating the deburring tip, wherein the tube includes a notch through which a portion of the deburring tip extends by an adjustable extent of exposure, for performing deburring, and wherein a central axis of the tube is eccentric to a central axis of the deburring tip when the deburring tip is mounted on the body so that the extent of exposure may be regulated by rotating the tube.

In some embodiments of the present invention, the adapter may include a base configured for mounting on the base, and a top with the tube rotatingly mounted over the base.

In some embodiments, the base may include internal threading for screwing the base onto a matching threading on the body.

In some embodiments, the base may include a distal portion formed as a cylinder having a wall of continuously varying width.

According to some embodiments of the invention, the central axis of the deburring tip coincides with a central axis of the base, and the central axis of the tube coincides with a central axis of the top.

In some embodiments, a clicking mechanism may be provided for audio indication of rotation of the tube with respect to the body.

The clickable mechanism may include a spring energized pin cooperating with peripheral dents in the adapter.

In some embodiments, the deburring tool may further be provided with a graphical marking of the extent of exposure.

In some embodiments, the graphical marking may include a tapering strip.

In some embodiments of the present invention, there is provided an adapter for a deburring tool, the deburring tool including a body designed to be hand-held and a rotatable deburring tip, mounted on or configured to be mounted on the body, which is configured to be rotated when powered by a power unit. The adapter is configured to be mounted over the deburring tip, when the deburring tip is mounted on the body, the adapted comprising a tube for at least partially accommodating the deburring tip, wherein the tube includes a notch through which a portion of the deburring tip extends by an adjustable extent of exposure, for performing deburring, and wherein a central axis of the tube is eccentric to a central axis of the deburring tip when the deburring tip is mounted on the body so that the extent of exposure may be regulated by rotating the tube.

### BRIEF DESCRIPTION OF THE DRAWINGS

In order to better understand the present invention, and appreciate its practical applications, the following figures are provided and referenced hereafter. It should be noted that the figures are given as examples only and in no way limit the scope of the invention. Like components are denoted by like reference numerals.

FIG. 1A illustrates a side view of an adjustable deburring tool, according to some embodiments of the present invention, with an adapter.

FIG. 1B illustrates an isometric view of the adjustable deburring tool shown in FIG. 1A, according to some embodiments of the present invention.

FIG. 2A illustrates a side view of an adjustable deburring tool, according to some embodiments of the present invention, without the adapter.

FIG. 2B illustrates an isometric view of the adjustable deburring tool shown in FIG. 2A, according to some embodiments of the present invention.

FIG. 3A illustrates a cross-sectional view of the adapter for an adjustable deburring tool shown in FIG. 1A, according to some embodiments of the present invention.

FIG. 3B illustrates an isometric view of the adapter for an adjustable deburring tool shown in FIG. 3A, according to some embodiments of the present invention.

FIG. 4 illustrates an exploded view of an adapter for an adjustable deburring tool, according to some embodiments of the present invention.

### DETAILED DESCRIPTION OF THE INVENTION

In the following detailed description, numerous specific details are set forth in order to provide a thorough understanding of the methods and systems. However, it will be understood by those skilled in the art that the present methods and systems may be practiced without these specific details. In other instances, well-known methods, procedures, and components have not been described in detail so as not to obscure the present methods and systems.

Although the examples disclosed and discussed herein are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method examples described herein are not constrained to a particular order or sequence. Additionally, some of the described method examples or elements thereof can occur or be performed at the same point in time.

Various aspects of the present invention are discussed herein, some of which are depicted in the accompanying drawings.

An object according to some embodiments is to provide an adjustable deburring tool that is capable of presenting a continuously variable profile of the deburring tip.

According to some embodiments of the present invention, an adjustable deburring tool may include a body designed to be hand-held; a rotatable deburring tip, mounted on or configured to be mounted on the body, which is configured to be rotated when powered by a power unit; and an adapter configured to be mounted over the deburring tip, when the deburring tip is mounted on the body, the adapter comprising a tube for at least partially accommodating the deburring tip, wherein the tube includes a notch through which a portion of the deburring tip extends by an adjustable extent of exposure, for performing deburring, and wherein a central axis of the tube is eccentric to a central axis of the deburring tip when the deburring tip is mounted on the body so that the extent of exposure may be regulated by rotating the tube.

Reference is now made to the accompanying figures.

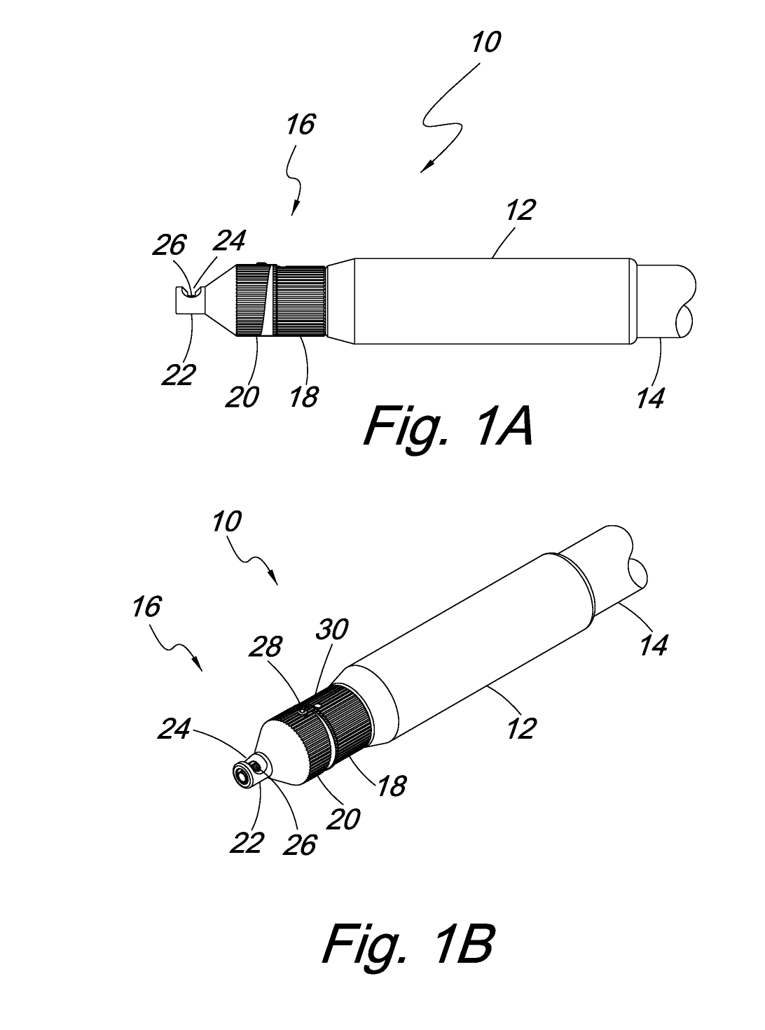

FIG. 1A illustrates a side view of an adjustable deburring tool 10, according to some embodiments of the present invention, with an adapter. Deburring tool 10 generally comprises body 12, which is designed to be hand-held by a user. Adapter 16 is mounted over an end of body 12 at which a deburring tip is located.

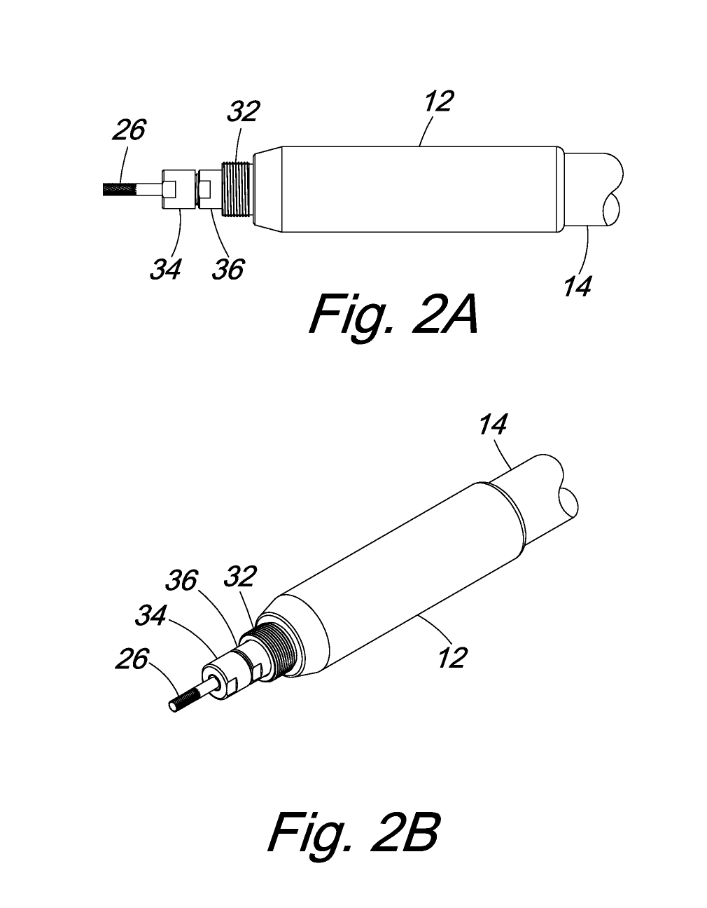

Adapter 16 comprises two main parts: cylindrical base 18 which is screwed over threading 32 (see FIG. 2A. 2B), and top 20 rotatingly mounted over base 18, and having a tube 22 on which a notch 24 is provided, so as to allow a portion of deburring tip 26 to be exposed and extend from notch 24, preventing deburring too deep, as the size of the notch, its opening angle and the extent of the exposure of the deburring tip define the depth of operation of the deburring tip on the workpiece. While the size and opening angle of the notch are manufacture-defined, the user may regulate the depth of operation by adjusting the extent of exposure of the deburring tip in a manner described hereinafter.

FIG. 2A illustrates a side view of an adjustable deburring tool, according to some embodiments of the present invention, without the adapter. Deburring tip 26 may be coupled to the tool by screwing it over holder elements 34 and 36 (which are designed so as to allow locking and unlocking of the deburring tip in position on the tool by rotating holder elements in opposite directions). Threading 32 is provided for adapter 16 to be mounted over deburring tip 26.

FIG. 1B illustrates an isometric view of the adjustable deburring tool shown in FIG. 1A, according to some embodiments of the present invention.

FIG. 2B illustrates an isometric view of the adjustable deburring tool shown in FIG. 2A, according to some embodiments of the present invention.

Deburring tool 10 is designed to be powered. Cable 14 (only a portion of the cable, coupled to the tool is shown) may be used to connect the tool to a power source, such as, for example, air or liquid pressure pump, electricity source, etc.)

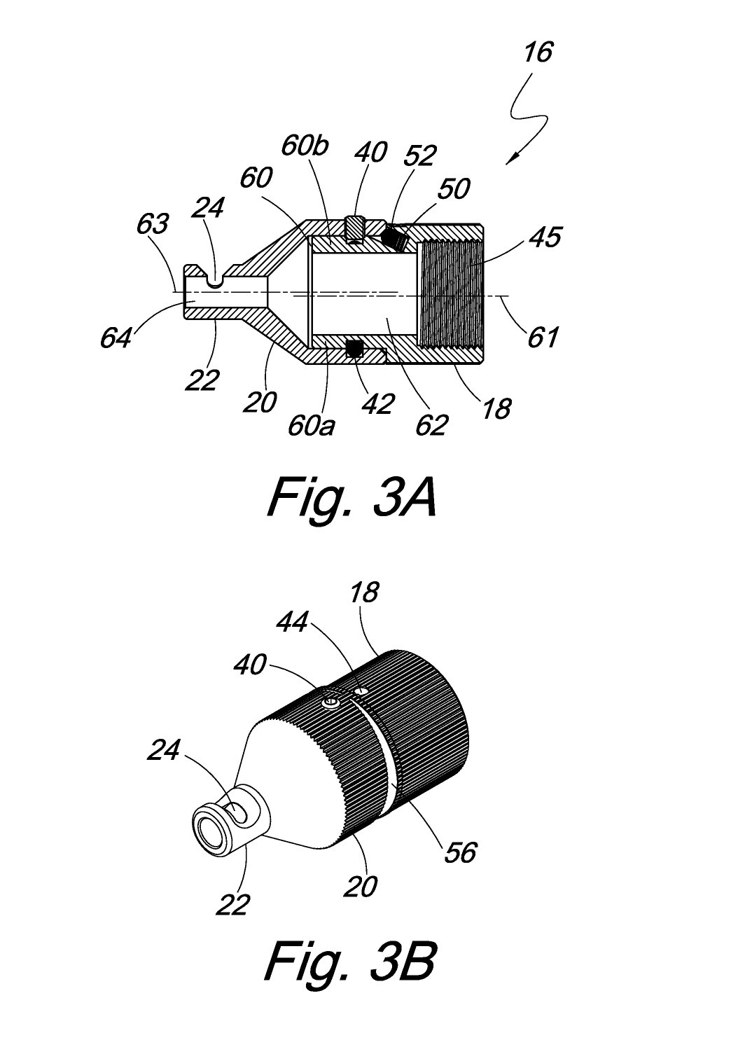

FIG. 3A illustrates a cross-sectional view of adapter 16 for an adjustable deburring tool shown in FIG. 1A, according to some embodiments of the present invention.

Adapter 16 comprises base 18, which is essentially a hollow cylindrical body, having a cavity 62 running through, with internal threading 45 at its proximal end, designed to be screwed over deburring tip 26 onto matching threading 32 (see FIGS. 2A and 2B).

Top 20 is mounted over distal portion 60 of base 18, and includes a narrowed portion extending in the form of a tube 22, whose internal cavity 64 is designed to accommodate deburring tip 26 (see FIG. 2A). Notch 24 on the side of tube 22 is provided so as to expose a portion the deburring tip (not shown in FIGS. 3A or 3B—see FIG. 1A and FIG. 1B). When it is desired to perform deburring on a workpiece, the user holds body 12 of deburring tool 10 (see FIG. 1A and FIG. 1B), and holds the exposed tip of the deburring tip to the workpiece at the location on the workpiece it is desired to perform deburring on. The length of tube 22 may preferably be predetermined so as to prevent the deburring tip from protruding from the end of the tube.

Distal portion 60 of base 18 is formed as a cylinder having a wall of continuously varying width (demonstrated in this cross-sectional view by wall widths 60a and 60b), so that the outer surface of the distal portion 60 of base 18 defines a cylinder whose central axis 63 is shifted (offset) with respect to the central axis 61 of base 18 at its proximal end. Thus, effectively, the central axis of top 20, which coincides with the central axis 63 of distal portion 60 of base 18, is shifted with respect to central axis 61 of base 18 that coincides with the central axis of the deburring tip.

The extent of exposure of the deburring tip through notch 24 may be regulated. Top 20 is designed to be rotated over base 18. As top 20 rotates over base 18, the extent of exposure of the burring tip through notch 24 changes, because of the eccentricity of top 20 with respect to base 18. Thus, a user may continuously determine the extent of exposure of the deburring tip by rotating the top 20 to obtain the desired exposure extent (the desired profile) of the deburring tip. Due to the geometry of the tool the maximal and minimal deburring tip profiles are determined by the length of the relative shift between the eccentric central axes of base 18 and top 20, and the depth of notch 24.

Rotating top 20 over base 18 in a single direction (clockwise or counter-clockwise), causes the extent of exposure of the exposed profile of the deburring tip to increase from the minimal exposure to the maximal exposure and then decrease and the top is further rotated in the same direction to the minimal exposure extent, and so on.

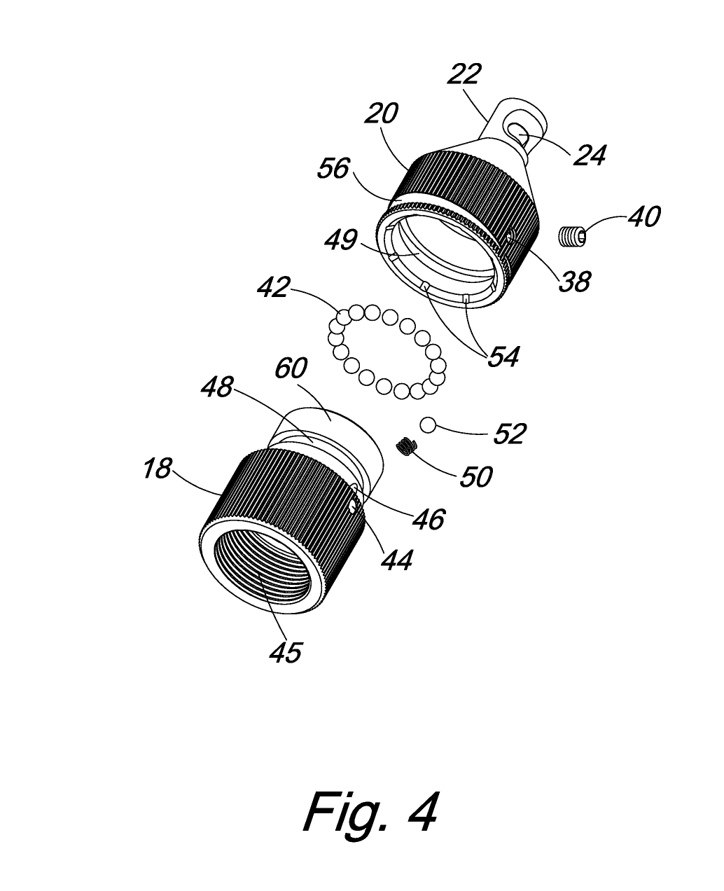

A plurality of balls 42, serving as ball bearings may be used to ease the rotation of top 20 with respect to base 18. Plug 40 may be used to block an opening (see 38 in FIG. 4) on the wall of top 20 through which balls 42 may be inserted into an annular groove (see groove 48 on distal portion 60 base 18 and corresponding groove 49 within top 20, in FIG. 4) that holds the balls.

A clickable mechanism may be provided for audio indication of rotation of the top (with the tube) with respect to the body. The clickable mechanism may include a floating element (e.g., ball 52), energized by spring 50 and is designed to provide audio confirmation of obtaining various states of exposure for the deburring tip, by cooperating with peripheral dents in the adapter, as ball 52 clicks into dents located on the peripheral rim of top 20 (see 54 in FIG. 4).

FIG. 3B illustrates an isometric view of the adapter for an adjustable deburring tool shown in FIG. 3A, according to some embodiments of the present invention.

Graphical marking 56, in the form of tapering strip, may be provided about the outer surface of top 20 so as to offer a user graphical indication of the extent of exposure of deburring tip. Mark 44 may be used to indicate the current exposure status of the deburring tip, determined by the position of mark 44 with respect to graphic marking 56.

FIG. 4 illustrates an exploded view of an adapter for an adjustable deburring tool, according to some embodiments of the present invention.

Dents 54 may be provided on the peripheral rim of top 20, so as to act as temporal hosts for ball 52 (e.g., in the form of a spike or a ball etc.), so that when top 20 is rotated clicks are heard indicating changes in the extent of exposure of the deburring tip through notch 24.

The opening angle of the notch 24 also controls the depth of operation. In some embodiments, the opening angle may range between 30 to 150 degrees. For many purposes, an opening angle of some 90 degrees or about that angle would be suitable. Thus, chamfer shape and depth may be maintained constant throughout the operation of the tool, without leaving any tool retraction marks.

An adjustable deburring tool according to some embodiments of the present invention allows the user to smoothly adjust the depth of operation when deburring, control the angle of operation (defined by the opening angle of the notch on the adapter), and easily engage and disengage with a power unit.

Using an adjustable deburring tool, in accordance with some embodiments of the present invention, facilitates reproducibility of operation results, regardless of the speed with which the user is advancing the tool over the workpiece (or vice versa).

In some embodiments of the present invention, the adapter, may be provided separately, to be mounted on an existing power grinding tool. Thus, once deburring is completed, the user may resume to using the tool as a grinding tool.

Features of various embodiments discussed herein may be used with other embodiments discussed herein. The foregoing description of the embodiments has been presented for the purposes of illustration and description. It is not intended to be exhaustive or limiting to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes that fall within the true spirit of the present invention.

1. An adjustable deburring tool comprising:
a body;
a rotatable deburring tip, mounted on or configured to be mounted on the body, which is configured to be rotated when powered by a power unit;
an adapter configured to be mounted over the deburring tip, when the deburring tip is mounted on the body, the adapter comprising a tube for at least partially accommodating the deburring tip, wherein the tube includes a notch through which a portion of the deburring tip extends by an adjustable extent of exposure, for performing deburring, and wherein a central axis of the tube is eccentric to a central axis of the deburring tip when the deburring tip is mounted on the body so that the extent of exposure is regulated by rotating the tube.

2. The tool of claim 1, wherein the body is configured to be hand-held

3. The tool of claim 1, wherein the adapter comprises a base configured for mounting on the body, and a top with the tube rotatingly mounted over the base.

4. The tool of claim 3, wherein the base includes internal threading for screwing the base onto a matching threading on the body.

5. The tool of claim 3, wherein the base includes a distal portion formed as a cylinder comprising a wall of continuously varying width.

6. The tool of claim 3, wherein the central axis of the deburring tip coincides with a central axis of the base, and the central axis of the tube coincides with a central axis of the top.

7. The tool of claim 3, wherein the extent of exposure is regulated by rotating the top over the base.

8. The tool of claim 2, provided with a clicking mechanism for audio indication of rotation of the tube with respect to the body.

9. The tool of claim 8, wherein the clicking mechanism comprises a spring energized floating element cooperating with peripheral dents in the adapter.

10. The tool of claim 1, further provided with a graphical marking of the extent of exposure.

11. The tool of claim 10, wherein the graphical marking comprises a tapering strip.

12. An adapter for a deburring tool, the deburring tool including a body and a rotatable deburring tip, mounted on or configured to be mounted on the body, which is configured to be rotated when powered by a power unit, the adapter configured to be mounted over the deburring tip, when the deburring tip is mounted on the body, the adapter comprising
a tube for at least partially accommodating the deburring tip, wherein the tube includes a notch through which a portion of the deburring tip extends by an adjustable extent of exposure, for performing deburring,
wherein a central axis of the tube is eccentric to a central axis of the deburring tip when the deburring tip is mounted on the body so that the extent of exposure is regulated by rotating the tube.

13. The adapter of claim 12, wherein the adapter comprises a base configured for mounting on the body, and a top with the tube rotatingly mounted over the base.

14. The adapter of claim 13, wherein the base includes internal threading for screwing the base onto a matching threading on the body.

15. The adapter of claim 13, wherein the base includes a distal portion formed as a cylinder having a wall of continuously varying width.

16. The adapter of claim 13, wherein the central axis of the deburring tip coincides with a central axis of the base, and the central axis of the tube coincides with a central axis of the top.

17. The adapter of claim 13, wherein the extent of exposure is regulated by rotating the top over the base.

18. The adapter of claim 12, provided with a clicking mechanism for audio indication of rotation of the tube with respect to the body.

19. The adapter of claim 18, wherein the clicking mechanism comprises a spring energized pin cooperating with peripheral dents in the adapter.

20. The adapter of claim 12, further provided with a graphical marking of the extent of exposure.
